(19) United States
(12) Patent Application Publication
(10) Pub. No.: US 2024/0157871 A1
(43) Pub. Date: May 16, 2024

(54) MULTI-PURPOSE VEHICLE LIGHTING SYSTEMS AND METHODS

(71) Applicant: Ford Global Technologies, LLC, Dearborn, MI (US)

(72) Inventors: Keith Weston, Canton, MI (US); Brendan Diamond, Grosse Pointe, MI (US); John Robert Van Wiemeersch, Nov, MI (US); Stuart C. Salter, White Lake, MI (US); Aaron Bradley Johnson, ALLEN PARK, MI (US)

(73) Assignee: Ford Global Technologies, LLC, Dearborn, MI (US)

(21) Appl. No.: 18/054,453

(22) Filed: Nov. 10, 2022

(51) Int. Cl. B60Q 1/50; B60Q 1/44; H05B 47/105

(52) U.S. Cl. CPC B60Q 1/5035; B60Q 1/44; B60Q 1/543; H05B 47/105

(57) ABSTRACT

A vehicle lighting system is disclosed. The vehicle lighting system may include a display unit configured to operate in a plurality of display modes. The display unit may be mounted on a vehicle rear top portion. The vehicle lighting system may further include a processor that may be configured to obtain trigger event information associated with the display unit. Based on the trigger event information, the processor may select a display mode from the plurality of display modes, and may activate the display unit responsive to the selection.

### TECHNICAL FIELD

The present disclosure relates to a multi-purpose vehicle exterior lighting system, and more particularly, to a center high mount stop lamp (CHMSL) that may be configured to operate in a plurality of different display modes.

### BACKGROUND

A vehicle may include various exterior lights for different purposes. For example, the vehicle may include a center high mount stop lamp (CHMSL), rear brake lights, turn indicators, headlamps, etc. Each light may serve one or more different purpose(s). For example, the CHMSL may be configured to provide an indication associated with lead vehicle braking to a trailing vehicle, so that the trailing vehicle may take appropriate actions when the lead vehicle applies brakes. The CHMSL is typically mounted on a vehicle cabin rear top portion, so that a trailing vehicle user may easily view the indication associated with the lead vehicle braking.

The vehicle may further include chase lights that may be mounted on a vehicle rear portion, and may be useful to increase lead vehicle visibility in harsh weather conditions. For example, the chase lights may be bright yellow or amber colored lights that may help the trailing vehicle user to see the lead vehicle in dusty, foggy, or rainy weather conditions.

While conventional exterior lights provide many benefits to vehicle users, there may be instances where the users may desire enhanced utility from exterior lights, without installing additional complex hardware to the vehicle.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example vehicle in which techniques and structures for providing the systems and methods disclosed herein may be implemented.

FIG. 2 depicts a block diagram of an example system to manage a vehicle display in accordance with the present disclosure.

FIG. 3 depicts an example display mode in accordance with the present disclosure.

FIG. 4 depicts another example display mode in accordance with the present disclosure.

FIG. 5 depicts an example display unit in accordance with the present disclosure.

FIG. 6 depicts a flow diagram of an example vehicle lighting system control method in accordance with the present disclosure.

### DETAILED DESCRIPTION

### Overview

The present disclosure describes a multi-purpose display unit that may be mounted on a vehicle rear portion. The display unit may be a center high mounted stop lamp (CHMSL) that may include a chase light, which may be selectively activated/deactivated. The display unit may operate in a plurality of display modes based on user inputs and/or different vehicle applications. For example, the display unit may display customized messages, vehicle load information, power usage information, and/or the like.

In some aspects of this disclosure, a vehicle processor may select a display mode for the display unit based on receipt of a trigger event associated with the vehicle. Specifically, the processor may obtain trigger event information from one or more vehicle sensors and user inputs. The trigger event information may include, for example, trigger event type (such as vehicle loading, vehicle braking, user request to display customized messages, etc.), trigger event timing, trigger event location, etc. Responsive to receiving the trigger event information, the processor may select an appropriate display mode for the display unit. The vehicle processor may further activate the display unit based on the selected display mode. For example, the processor may activate the chase light when the ambient weather condition is foggy or dusty and the processor detects a trailing vehicle.

In further aspects, the display unit may include multiple light bars that may be mounted on a vehicle top portion in different directions. For instance, a first light bar may align towards a vehicle rear portion, a second light bar may align towards a vehicle left portion, a third light bar may align towards a vehicle right portion, and a fourth light bar may align towards a vehicle front portion. In some aspects, the processor may operate the multiple light bars simultaneously and independently of each other.

The present disclosure discloses a display unit that may be used for different purposes. A single display unit may perform multiple lighting functions, and thus eliminates the need to install different vehicle exterior lights for different purposes. Further, the present disclosure facilities in saving vehicle exterior rear space, as the user is not required to install multiple lighting systems.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

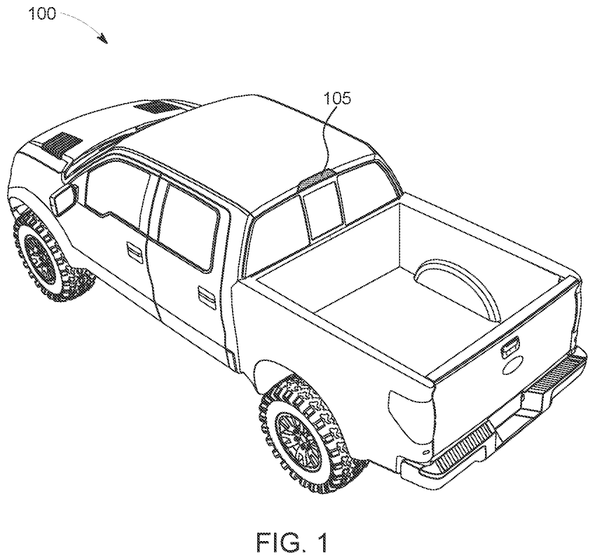

FIG. 1 depicts an example vehicle 100 in which techniques and structures for providing the systems and methods disclosed herein may be implemented. The vehicle 100 may take the form of any passenger or commercial vehicle such as, for example, a car, a work vehicle, a crossover vehicle, a van, a minivan, a taxi, a bus, etc. Further, the vehicle 100 may be a manually driven vehicle, and/or may be configured to operate in a fully autonomous (e.g., driverless) mode or a partially autonomous mode, and may include any powertrain such as, for example, a gasoline engine, one or more electrically-actuated motor(s), a hybrid system, etc.

The vehicle 100 may include a vehicle display unit. In some aspects, the vehicle display unit may include a center high mount stop lamp (CHMSL) 105. The CHMSL 105 may include light emitting diodes (LEDs), bulbs, flashers, lamps and/or the like. The CHMSL 105 may be configured to activate when a vehicle processor (not shown) obtains a trigger event information associated with the vehicle 100. For example, the vehicle processor may send a control signal to the CHMSL 105 for activation when a vehicle user (not shown) applies vehicle brakes. CHMSL 105 activation may provide an indication to a trailing vehicle (not shown) that the vehicle 100 may have applied brakes and hence a vehicle 100 speed may slow down, so that the trailing vehicle may take appropriate actions.

The CHMSL 105 may be disposed at a vehicle exterior portion. In some aspects, the CHMSL 105 may be disposed at a vehicle rear top portion (e.g., at or near a rear window top portion or a vehicle cab rear top portion), as shown in FIG. 1. Alternatively, the CHMSL 105 may be disposed on a vehicle hatchback frame or structure.

The CHMSL 105 may be of any length and/or width, as permissible in Federal Motor Vehicle Safety Standards (FMVSS), Economic Commission for Europe (ECE) guidelines associated with the CHMSLs, and/or other local regulations or standards. Specifically, the CHMSL 105 may be of any shape that may be based on vehicle window dimensions or structure (or vehicle top portion dimensions or structure). For example, the CHMSL 105 may cover 30-90% of a rear window top portion length. In some aspects, the CHMSL 105 may be mounted at a center position on a rear window. In further aspects, the CHMSL 105 may be mounted on a vehicle top portion, above the rear window. The CHMSL 105 may be formed of plastic, aluminum, or any other similar material known in the art. Further, the CHMSL 105 may be attached to the vehicle 100 by using any appropriate technique, component, material, or fastener.

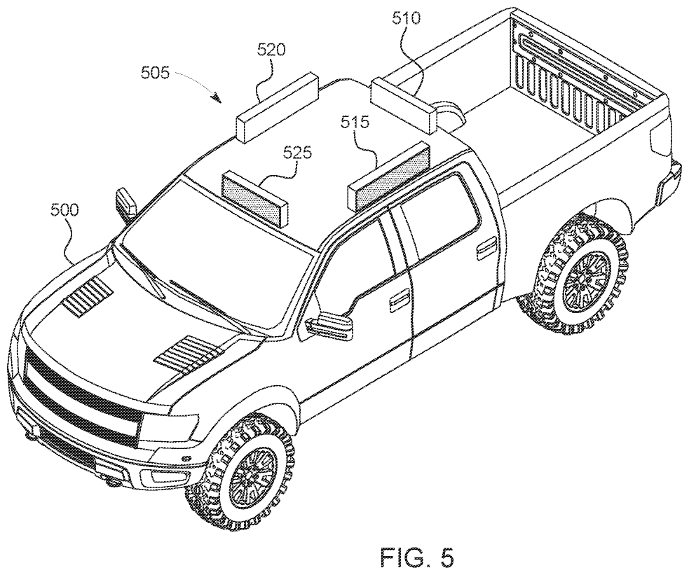

In further aspects, the CHMSL 105 may be configured to rotate (not shown) at a predefined angle based on user requirements. For example, the CHMSL 105 may rotate 180 degrees to perform different functions, as described later in the description below. In other aspects, the CHMSL 105 may include multiple display screens or multiple light bars (not shown) that may be located at a predefined angle with respect to each other. The multiple light bars may be located on the vehicle top portion, and may be positioned in a square or a rectangular arrangement. For example, a first light bar may face towards a vehicle rear portion, a second light bar may face towards a vehicle left portion, a third light bar may face towards a vehicle right portion, and a fourth light bar may face towards a vehicle front portion. An exemplary embodiment of the multiple light bars is shown in FIG. 5, and described later in the description below. In further aspects, the CHMSL 105 may include thin-film transistor (TFT), liquid crystal display (LCD) or any other digital screen technology.

In some aspects, the CHMSL 105 may include a chase light. Stated another way, the chase light may be integrated with the CHMSL 105. The chase light may be located at a CHMSL 105 center portion or at opposing CHMSL 105 edges (e.g., a left and a right CHMSL edge). The chase light may be configured to increase vehicle 100 visibility. In particular, the chase light may help other vehicle users (e.g., a trailing vehicle user) to see the vehicle 100 in harsh weather conditions, e.g., dusty, foggy, snowy or rainy weather conditions. The chase light may include yellow and amber lights to provide better vehicle 100 visibility to trailing vehicles.

By integrating the chase light with the CHMSL 105, the CHMSL 105 may be used to increase the vehicle 100 visibility, without adding any complex hardware to the vehicle 100. Further, the chase light integration with the CHMSL 105 helps in saving vehicle exterior surface space, as two separate lighting systems (the CHMSL and the chase lights) are not required to be installed at the vehicle rear portion.

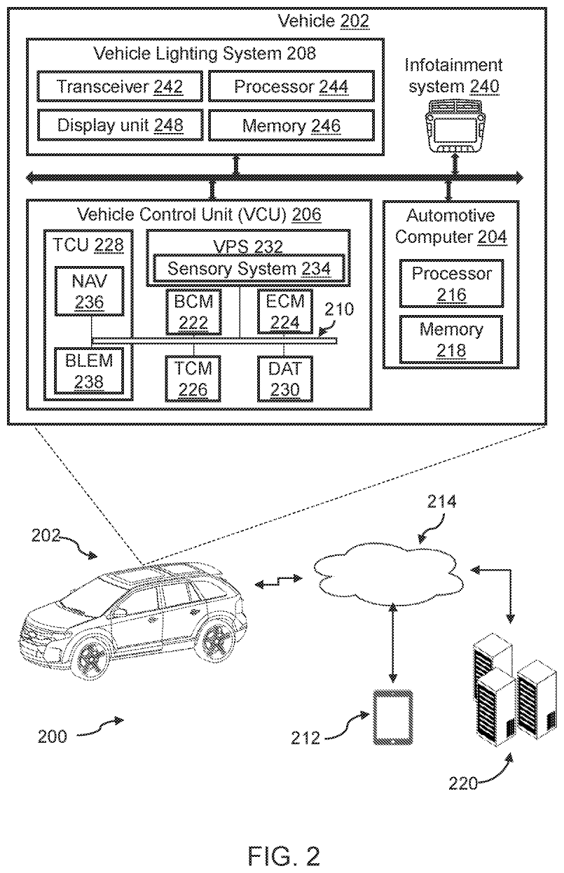

In some aspects, the CHMSL 105 may be configured to perform additional functions, in addition to providing indication associated with vehicle 100 braking to the trailing vehicles and increasing the vehicle 100 visibility in harsh weather conditions. Stated another way, the CHMSL 105 may perform multiple functions based on user requirements/circumstances. For instance, the CHMSL 105 may be configured to provide an indication associated with vehicle loading/load balancing (by using a vehicle on-board weight scale, not shown), indicate vehicle onboard power usage, display custom messages or advertisements, provide a security surveillance indication, and/or the like. The details of the additional functions may be understood in conjunction with FIGS. 2-5.

In further aspects, the CHMSL 105 may be configured to operate in different display modes to perform the different functions mentioned above. In particular, the CHMSL 105 may operate in different display modes based on different trigger events (i.e., trigger events information that may include information associated with the trigger events such as event type, event timing, etc.). For example, when the vehicle processor detects another vehicle in a vehicle 100 rear proximity, the vehicle processor may activate a first CHMSL 105 display mode. In the first display mode, the vehicle processor may activate the chase light in the CHMSL 105. Stated another way, the chase light may be generally turned-off to save power, and the vehicle processor may activate the chase light when the vehicle processor detects the other vehicle in the vehicle 100 rear proximity. As another example, the vehicle processor may cause the CHMSL 105 to display custom messages based on inputs received from the vehicle user. In this case, the vehicle user may send a request to the vehicle processor, via a user device or a vehicle Human Machine Interface (HMI, not shown), to display the custom message on the CHMSL 105. Responsive to receiving the request, the vehicle processor may display the message on the CHMSL 105. In some aspects, the CHMSL 105 may display customized (or default) messages when the user having a vehicle 100 key fob approaches near to the vehicle 100, or leaves the vehicle 100. In this case, in an exemplary aspect, the default messages may be associated with “Welcome” or “Farewell” messages.

The vehicle processor may further receive Over-the-Air updates for the CHMSL 105 operation. The updates may be associated with FMVSS and/or ECE guidelines. The vehicle processor may operate the CHMSL 105 as per the guidelines. For instance, one or more display modes may be activated when the vehicle 100 is stationary. On the other hand, one or more display modes may be deactivated when the vehicle 100 is in motion, as per FMVSS and/or ECE guidelines.

FIG. 2 depicts a block diagram of an example system 200 to manage the vehicle display in accordance with the present disclosure. The system 200 may include a vehicle 202. The vehicle 202 may be same as the vehicle 100. The vehicle 202 may include an automotive computer 204, a Vehicle Control Unit (VCU) 206, and a vehicle lighting system 208. The VCU 206 may include a plurality of Electronic Control Units (ECUs) 210 disposed in communication with the automotive computer 204.

The system 200 may further include a mobile device 212 that may connect with the automotive computer 204 and/or the vehicle lighting system 208 by using wired and/or wireless communication protocols and transceivers. In some aspects, the mobile device 212 may be associated with a vehicle 202 user/operator (not shown in FIG. 2). The mobile device 212 may communicatively couple with the vehicle 202 via one or more network(s) 214, which may communicate via one or more wireless connection(s), and/or may connect with the vehicle 202 directly by using near field communication (NFC) protocols, Bluetooth® protocols, Wi-Fi, Ultra-Wideband (UWB), and other possible data connection and sharing techniques.

The network(s) 214 illustrates an example communication infrastructure in which the connected devices discussed in various embodiments of this disclosure may communicate. The network(s) 214 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the automotive computer 204 and/or some vehicle lighting system 208 components may be installed in a vehicle engine compartment (or elsewhere in the vehicle 202) and operate as a functional part of the vehicle lighting system 208, in accordance with the disclosure. The automotive computer 204 may be or include an electronic vehicle controller, having one or more processor(s) 216 and a memory 218. Moreover, some vehicle lighting system 208 components may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable memory storing a vehicle lighting/display modes program code. The memory 218 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

In some aspects, the automotive computer 204 and/or the vehicle lighting system 208 may be disposed in communication with one or more server(s) 220, and the mobile device 212. The server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In some aspects, the server 220 may also store information associated with the vehicle user. For example, the server 220 may store information associated with user/vehicle daily activities such as picking or dropping of vehicle occupants, user's vehicle settings/preferences, etc.

In accordance with some aspects, the VCU 206 may share a power bus with the automotive computer 204, the vehicle lighting system 208, and may be configured and/or programmed to coordinate the data between vehicle 202 systems, connected servers (e.g., the server(s) 220), and other vehicles (not shown in FIG. 2) operating as part of a vehicle fleet. The VCU 206 can include or communicate with any combination of the ECUs 210, such as, for example, a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 206 may further include and/or communicate with a Vehicle Perception System (VPS) 232, having connectivity with and/or control of one or more vehicle sensory system(s) 234. The vehicle sensory system 234 may include one or more vehicle sensors including, but not limited to, an on-board weight scale, vehicle power usage (e.g., pro power) sensors, Radio Detection and Ranging (RADAR or “radar”) sensor configured for detection and localization of objects outside the vehicle 202 using radio waves, vehicle brake sensors, environment sensors (such as fog, dust, rain sensors), etc.

In some aspects, the VCU 206 may control vehicle 202 operational aspects and implement one or more instruction sets received from the mobile device 212, from one or more instruction sets stored in the memory 218, including instructions operational as part of the vehicle lighting system 208.

The TCU 228 can be configured and/or programmed to provide vehicle connectivity to wireless computing systems onboard and off board the vehicle 202, and may include a Navigation (NAV) receiver 236 for receiving and processing a GPS signal, a BLE® Module (BLEM) 238, a Wi-Fi transceiver, a UWB transceiver, and/or other wireless transceivers (not shown in FIG. 2) that may be configurable for wireless communication between the vehicle 202 and other systems, computers, and modules. The TCU 228 may be disposed in communication with the ECUs 210 by way of a bus.

In one aspect, the ECUs 210 may control aspects of vehicle operation and communication using inputs from human drivers, inputs from an autonomous vehicle controller, the vehicle lighting system 208, and/or via wireless signal inputs received via the wireless connection(s) from other connected devices, such as the mobile device 212, the server(s) 220, among others.

The BCM 222 generally includes integration of sensors, vehicle performance indicators, and variable reactors associated with vehicle systems, and may include processor-based power distribution circuitry that can control functions associated with the vehicle body such as lights (such as the CHMSL 105 discussed in FIG. 1), windows, security, camera(s), audio system(s), speakers, a vehicle fragrance system, door locks and access control, vehicle energy management, and various comfort controls. The BCM 222 may also operate as a gateway for bus and network interfaces to interact with remote ECUs (not shown in FIG. 2).

In some aspects, the DAT controller 230 may provide Level-1 through Level-3 automated driving and driver assistance functionality that can include, for example, active parking assistance, trailer backup assistance, adaptive cruise control, lane keeping, and/or driver status monitoring, among other features. The DAT controller 230 may also provide aspects of user and environmental inputs usable for user authentication.

In some aspects, the automotive computer 204 may connect with an infotainment system 240 that may include a touchscreen interface portion, and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion, and/or display notifications, navigation maps, etc. on the touchscreen interface portion.

The computing system architecture of the automotive computer 204, the VCU 206, and/or the vehicle lighting system 208 may omit certain computing modules. It should be readily understood that the computing environment depicted in FIG. 2 is an example of a possible implementation according to the present disclosure, and thus, it should not be considered limiting or exclusive.

In accordance with some aspects, the vehicle lighting system 208 may be integrated with and/or executed as part of the ECUs 210. The vehicle lighting system 208, regardless of whether it is integrated with the automotive computer 204 or the ECUs 210, or whether it operates as an independent computing system in the vehicle 202, may include a transceiver 242, a processor 244, a computer-readable memory 246 and a display unit 248 (which may be same as the CHMSL 105 of FIG. 1). The transceiver 242 may be configured to receive information/inputs (such as the trigger events) from external devices or systems, e.g., the mobile device 212, the server 220, the VCU 206 (including the sensory system 234), the infotainment system 240, and/or the like. Further, the transceiver 242 may transmit notifications/trigger event information to the display unit 248 and/or the processor 244.

The processor 244 and the memory 246 may be same as or similar to the processor 216 and the memory 218, respectively. Specifically, the processor 244 may utilize the memory 246 to store programs in code and/or to store data for performing aspects in accordance with the disclosure. The memory 246 may be a non-transitory computer-readable memory storing the vehicle lighting/display mode program code.

As described above, the CHMSL 105 (same as the display unit 248) may be configured to operate in different modes to perform various functions. The processor 244 (or the processor 216) may be configured to obtain a trigger event information associated with the display unit 248 or the vehicle 202, select a display mode from the plurality of display modes for the CHMSL 105 based on the trigger event information, and activate the CHMSL 105 based on the selection.

In some aspects, the processor 244 may receive/obtain the trigger event information from the sensory system 234 or from the vehicle user via the mobile device 212 (or any other user device). For example, when the sensory system 234 detects (via vehicle radar sensors) a trailing vehicle (not shown) in proximity to a vehicle 202 rear portion, the sensory system 234 may send a signal to the processor 244 indicating a trailing vehicle presence. Responsive to obtaining the trailing vehicle presence signal, the processor 244 may select a first display mode from the plurality of display modes for the CHMSL 105. In particular, the processor 244 may activate the chase light present in the CHMSL 105 responsive to obtaining the trailing vehicle presence signal. Stated another way, the processor 244 may activate the chase light in the first display mode.

In further aspects, the processor 244 may activate the chase light (i.e., the first display mode of the CHMSL 105) when the vehicle 202 is moving in a harsh environment. In particular, the processor 244 may receive/obtain environment information from the environment sensors (such as fog, dust, rain sensors) of the sensory system 234, and may determine presence of fog, dust, rain, etc. in the environment. Responsive to determining the harsh environment, the processor 244 may activate the chase light. In this case, the processor 244 may activate the chase light even when there is no trailing vehicle in proximity to the vehicle 202 rear portion.

In yet another aspect, the processor 244 may activate the chase light when the processor 244 receives/obtains user input from the mobile device 212 to activate the chase light. In this case too, the processor 244 may activate the chase light even when there is no trailing vehicle.

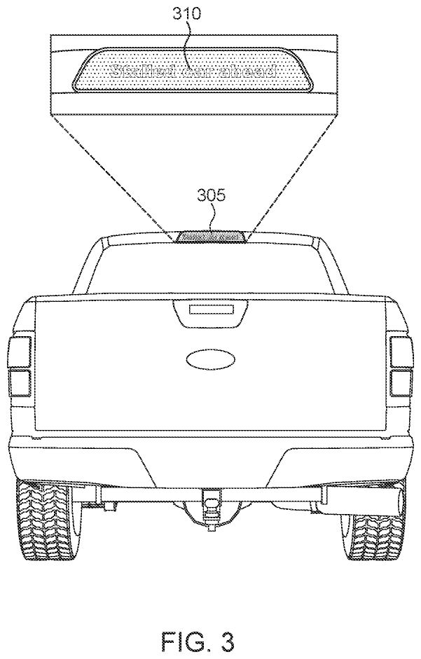

Other CHMSL 105/display unit 248 display modes may be understood in conjunction with FIGS. 3-5.

FIG. 3 depicts an example display mode in accordance with the present disclosure. In particular, FIG. 3 depicts a display mode (e.g., a second display mode) in which a display unit 305 (same as the display unit 248) may display a customized message 310. In this case, the processor 244 may obtain a request (which may be the “trigger event”, as described above) from the vehicle user, via the mobile device 212 or the infotainment system 240, to display the customized message 310 on the display unit 305. In some aspects, the user may provide customized message 310 content along with the request to display the customized message 310. For example, the user may type the customized message 310 content on a keyboard associated with the infotainment system 240 or the mobile device 212, and send the customized message 310 content to the processor 244 to display the message 310 on the display unit 305. In such scenario, the processor 244 may analyze the message 310 and may filter inappropriate words or messages. In additional aspects, the user may select the message 310 from a list of pre-stored message(s) to display on the display unit 305. In further aspects, the user may use a digital assistant (e.g., Amazon™ Alexa™, Apple™ Siri™) to compose the message 310 and display on the display unit 305. In particular, the digital assistant may receive audio inputs from the user and may use speech recognition means to compose the message 310. The digital assistance may then transmit the message 310 to the processor 244 for display on the display unit 305.

In other aspects, the user may indicate in the request a time at which the processor 244 may display the message 310 on the display unit 305. For example, the user may indicate that the processor 244 may display the message 310 at a specific time in the future, e.g., 4:30 PM, 6:30 PM, and/or the like. In yet another aspect, the user may indicate in the request a vehicle 202 location at which the processor 244 may display the message 310 on the display unit 305. For example, the user may indicate that the processor 244 may display the message 310 when the vehicle 202 reaches the airport. In this case, the processor 244 may obtain the vehicle 202 geo-location from the TCU 228 (specifically the NAV receiver 236) to determine the vehicle 202 geo-location. When the vehicle 202 geo-location is the airport, the processor 244 may display the message 310.

In additional aspects, the user may indicate in the request that the processor 244 may display one or more pre-stored messages on the display unit 305 at a specific time and/or vehicle 202 location. In this case, the messages may be pre-stored in the memory 246/218 or the server 220. At the user specified time and/or vehicle 202 location, the processor 244 may fetch the pre-stored message and may display the message on the display unit 305.

In further aspects, the processor 244 may automatically display the pre-stored message based on user's daily activities (that may be stored in the memory 246/218 or the server 220). In this case, the processor 244 may fetch the user's daily activities from the memory 246/218 or the server 220, and determine user's travel pattern and message display request instructions. For example, the processor 244 may determine that the user visits school every day at 3 PM and displays the message “Here to pick-up Thomas” on the display unit 305. Responsive to determining this pattern, the processor 244 may automatically display the message “Here to pick-up Thomas” on the display unit 305, when the vehicle 202 reaches the school at 3 PM. In this case, the processor 244 may determine whether the vehicle 202 has reached the school by using the vehicle 202 geo-location, as obtained from the NAV receiver 236.

In the example described above, in some aspects, the processor 244 may seek the user's authorization before displaying the message. In this case, the processor 244 may display a message, e.g., “Should the display unit display “Here to pick-up Thomas”?” on the mobile device 212 or the infotainment system 240 when the vehicle 202 reaches the school. The user may then authorize the display of the message on the display unit 305. Responsive to receiving the user authorization, the processor 244 may display the message on the display unit 305.

In a similar manner, if the display unit 305 is mounted on a ridesharing vehicle, the processor 244 may display an occupant name during pick-up (as an example) on the display unit 305. In addition, the processor 244 may display a ridesharing firm's logo on the display unit 305.

In further aspects, the processor 244 may display police lights on the display unit 305. Similarly, a construction worker may display a customized message on the display unit 305 to provide a specific message/indication to users in trailing vehicle. For example, if the display unit 305 is mounted on a construction truck, the processor 244 may display a customized message “Road ahead under construction” on the display unit 305.

In further aspects, the display unit 305 may be configured to display messages to communicate with other vehicles (including drones). For example, the display unit 305 may display a message “stalled car ahead” to communicate this message to the trailing vehicles. Similarly, the display unit 305 may display a message “pedestrian crossing my vehicle,” “dropping off occupant,” “waiting for occupant pick-up”, and/or the like.

In addition, the display unit 305 may provide indication associated with vehicle 202 security surveillance. In particular, the processor 244 may display a preset message, e.g., “This vehicle includes security surveillance cameras”, when the processor 244 determines (e.g., by using the radar sensors) that a person is near to the vehicle 202.

In additional aspects, the display unit 305 may be used for advertisement purposes as well. For example, the display unit 305 may display a preset advertisement content/message (or any other preset message), when the processor 244 detects one or more people near to the vehicle 202. For example, the display unit 305 may display preset welcome or farewell messages when a vehicle owner (having a key fob) approaches or leaves the vehicle 202. In an alternative aspect, the display unit 305 may display the preset advertisement content/message, even when no people are near to the vehicle 202. In this case, the processor 244 may configure the display unit 305 to display the advertisement content/message for a preset time duration (e.g., for three or four hours) and/or when the vehicle 202 is stationed at a predefined geo-location (e.g., at a mall).

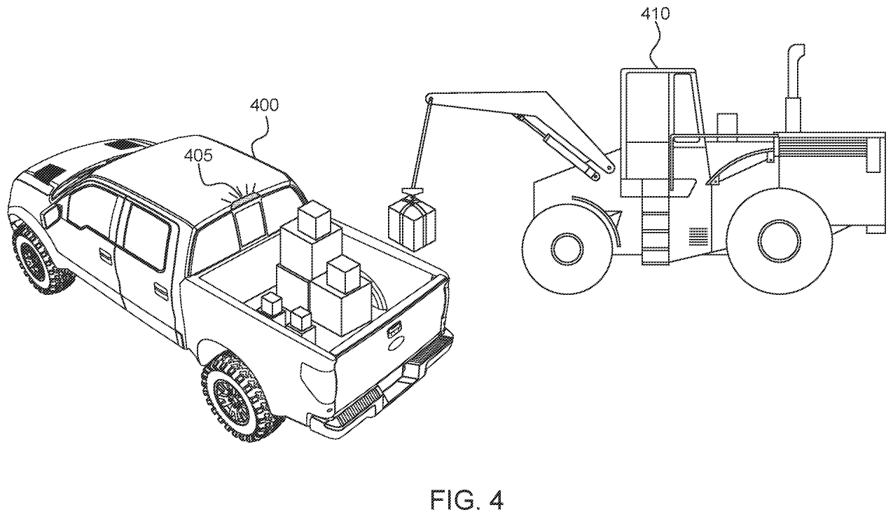

FIG. 4 depicts another example display mode in accordance with the present disclosure. In particular, FIG. 4 depicts a vehicle 400 that may include a display unit 405. The vehicle 400 may be same as the vehicle 202 and the display unit 405 may be same as the display unit 248. In some aspects, the vehicle 400 may be a pickup truck that may be configured to deliver cargo or delivery packages.

The display unit 405 may be configured to display load information or load balancing information during vehicle 400 loading or unloading operation. In this case, the processor 244 may receive vehicle load information (which may be the “trigger event”, as described above) from the on-board weight scale of the sensory system 234 when the user loads cargo on a vehicle cargo bed. The load information may include, for example, a cargo weight added to the vehicle cargo bed.

Responsive to receiving the load information, the processor 244 may activate a third display mode for the display unit 405. The processor 244 may transmit the load information to the display unit 405, and cause the display unit 405 to display the load information. This way, the user may view the load information during the vehicle 400 loading operation, without requiring moving inside the vehicle 400 and viewing the load information on the infotainment system 240 (as an example).

As an example, when a crane 410 loads the vehicle 400, the display unit 405 may indicate the load information. In some aspects, the display unit 405 may display numbers (e.g., the cargo total weight, cargo left side weight or right side weight) to indicate the load information on the vehicle cargo bed. In other aspects, the display unit 405 may indicate the load information by progressively blinking lights in the display unit 405. As an example, the display unit 405 may blink one or two lights when the cargo weight is less than a predetermined threshold, and may blink three or more lights as the cargo weight increases progressively. In yet another aspect, the display unit 405 may blink left and right lights corresponding to whether the cargo weight is increased on left or right vehicle cargo bed portion. For example, if the crane 410 loads 100 kilograms (Kgs) of cargo to the left vehicle cargo bed portion and 20 Kgs to the right vehicle cargo bed portion, the display unit 405 may blink five left lights and one right light. A person ordinarily skilled in the art may appreciate that such an arrangement of blinking lights may assist the user in load balancing on the vehicle cargo bed.

In further aspects, the processor 244 may obtain information associated with vehicle power usage (e.g., pro power usage) from the vehicle power usage sensors of the sensory system 234, and may activate a fourth display mode of the display unit 405. In particular, in the fourth display mode, the processor 244 may obtain pro power usage information (such as power consumption information) from the vehicle power usage sensors, and may transmit the pro power usage information to the display unit 405. The display unit 405 may display the pro power usage information so that the user may not have to go to inside the vehicle 400 and view the power usage information on the infotainment system 240. In particular, the display unit 405 may display numbers associated with pro power usage information on the display unit 405 to indicate the power being consumed. In some aspects, the display unit 405 may blink a number of lights (e.g., two or four lights) to indicate the pro power usage information. In other aspects, the display unit 405 may display a message to provide the indication. In further aspects, the display unit 405 may display different colors of the lights based on the power consumption.

In some aspects, the display unit 405 may display the pro power usage information when the user is near/proximate to a vehicle pro power socket (as determined by the processor 244 via the vehicle radar sensors and/or exterior vehicle cameras).

FIG. 5 depicts an example display unit 505 in accordance with the present disclosure. The display unit 505 may be installed on a vehicle 500. Specifically, the display unit 505 may be installed on a vehicle 500 top portion, as shown in FIG. 5. The vehicle 500 may be same as the vehicle 202 or 400. The display unit 505 may be same as the display unit 248, 305, 405.

The display unit 505 may include multiple display screens or light bars that may be located at a predefined angle with respect to each other. The multiple light bars may be located on the vehicle 500 top portion, and may be positioned in a square or rectangular arrangement. For example, a first light bar 510 may face towards a vehicle 500 rear portion, a second light bar 515 may face towards a vehicle 500 left portion, a third light bar 520 may face towards a vehicle 500 right portion, and a fourth light bar 525 may face towards a vehicle 500 front portion. The light bars 510-525 may be placed at vehicle top edges, as shown in FIG. 5. In other aspects (not shown), the light bars 510-525 may be placed towards the vehicle 500 rear portion as a single device. In some aspects, all the light bars 510-525 may be the same or different from each other. For instance, only the light bar 510 may have the integrated chase light, and/or the light bar 515/520 may be configured to display messages (e.g., advertisement messages or customized messages).

In some aspects, the processor 244 may be configured to control the light bars 510-525 simultaneously. In further aspects, the processor 244 may control the light bars 510-525 independently. For instance, the processor 244 may activate the first display mode for the light bar 510 and the second display mode for the light bar 515 simultaneously and independent of each other.

In further aspects, the display unit 505 (or one of the light bars 510-525) may be configured to operate as an auxiliary lamp or a backup bed lamp to provide superior lighting (e.g., to the vehicle cargo bed).

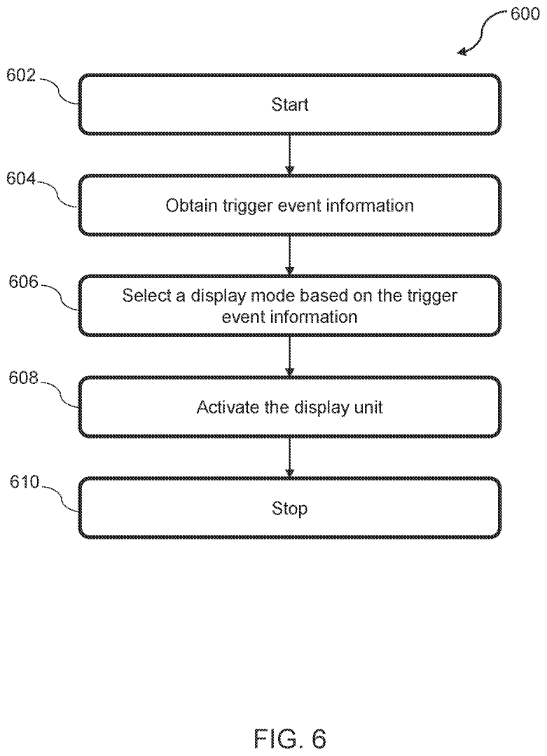

FIG. 6 depicts a flow diagram of an example vehicle lighting system control method 600 in accordance with the present disclosure. FIG. 6 may be described with continued reference to prior figures, including FIGS. 1-5. The following process is exemplary and not confined to the steps described hereafter. Moreover, alternative embodiments may include more or less steps that are shown or described herein and may include these steps in a different order than the order described in the following example embodiments.

The method 600 starts at step 602. At step 604, the method 600 may include obtaining, by the processor 244, a trigger event information (including event type and event timing) associated with the display unit 248. In particular, the processor 244 may obtain the trigger event information from the mobile device 212, the server 220, the VCU 206 (including the sensory system 234), the infotainment system 240, and/or the like.

At step 606, the method 600 may include selecting, by the processor 244, a display mode from a plurality of display modes associated with the display unit 248. The processor 244 may select the display mode based on the trigger event information. The details of the display mode(s) may be understood in conjunction with FIGS. 2-5.

At step 608, the method 600 may include activating, by the processor 244, the display unit 248 responsive to the selection. In particular, the processor 244 may activate the display unit 248 based on the selected display mode. For example, the processor 244 may activate the chase light, display messages (on one or more light bars), display load information, etc. as described above. The method 600 ends at step 610.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

1. A vehicle lighting system comprising:
a configurable center high mounted stop lamp (CHMSL) configured to operate in a plurality of display modes, wherein the CHMSL is configured to be mounted on a rear top portion of a vehicle; and
a processor communicatively coupled to the configurable CHMSL, wherein the processor is configured to:
obtain trigger event information associated with the configurable CHMSL, the trigger event information including at least one of: a current day or time;
select a display mode from the plurality of display modes based on the trigger event information; and
activate, based on the display mode, the configurable CHMSL.

2. (canceled)

3. The vehicle lighting system of claim 1, wherein the processor obtains the trigger event information from a vehicle sensor or a user device.

4. The vehicle lighting system of claim 1, wherein the configurable CHMSL comprises a chase light.

5. The vehicle lighting system of claim 4, wherein the plurality of display modes comprises a first display mode, and wherein the processor is further configured to activate the chase light in the first display mode.

6. The vehicle lighting system of claim 5, wherein the processor is further configured to detect a vehicle in a rear proximity, and wherein the processor activates the first display mode when the processor detects the vehicle in the rear proximity.

7. The vehicle lighting system of claim 1, wherein the plurality of display modes comprises a second display mode, and wherein the processor is further configured to display a message on the CHMSL in the second display mode.

8. The vehicle lighting system of claim 7, wherein the processor is further configured to:
obtain the message as an input provided by a vehicle user;
activate the second display mode in response to obtaining the message; and
transmit the message to the configurable CHMSL based on the second display mode being activated, and
wherein the configurable CHMSL is configured to display the message in response to receiving the message.

9. The vehicle lighting system of claim 1, wherein the plurality of display modes comprises a third display mode, and wherein the processor is configured to display a load information on the configurable CHMSL in the third display mode.

10. The vehicle lighting system of claim 9, wherein the processor is further configured to:
obtain the load information from a vehicle on-board scale;
activate the third display mode in response to obtaining the load information; and
transmit the load information to the configurable CHMSL based on the third display mode being activated, and
wherein the configurable CHMSL is configured to display the load information in response to receiving the load information, the load information providing an indication of a weight of a load in a bed of the vehicle.

11. The vehicle lighting system of claim 1, wherein the configurable CHMSL is configured to rotate.

12. The vehicle lighting system of claim 1, wherein the configurable CHMSL comprises a plurality of display screens that is placed at a predetermined angle with each other.

13. The vehicle lighting system of claim 12, wherein the processor is configured to activate the plurality of display screens simultaneously.

14. The vehicle lighting system of claim 13, wherein the processor is configured to activate a display mode of each display screen independently.

15. A method to control a vehicle lighting system, the method comprising:
obtaining, by a processor, a trigger event information associated with a display unit of the vehicle lighting system, wherein the trigger event information includes at least one of: a current day or time, wherein the display unit is configured to be mounted on a vehicle rear top portion, and wherein the display unit is configured to operate in a plurality of display modes;
selecting, by the processor, a display mode from the plurality of display modes based on the trigger event information; and
activating, by the processor, the display unit responsive to the selection.

16. The method of claim 15, wherein activating the display unit comprises activating a first display mode, and wherein the activating the first display mode comprises activating a chase light of the display unit.

17. The method of claim 15, wherein activating the display unit comprises activating a second display mode, and wherein the activating the second display mode comprises displaying a message on the display unit.

18. The method of claim 15, wherein activating the display unit comprises activating a third display mode, and wherein the activating the third display mode comprises displaying a load information on the display unit.

19. The method of claim 15, further comprising obtaining the trigger event information from a vehicle sensor or a user device.

20. A non-transitory computer-readable storage medium having instructions stored thereupon which, when executed by a processor, cause the processor to:
obtain a trigger event information associated with a display unit of a vehicle lighting system, wherein the trigger event information includes at least one of: a current day or time, wherein the display unit is configured to be mounted on a vehicle rear top portion, and wherein the display unit is configured to operate in a plurality of display modes;
select a display mode from the plurality of display modes based on the trigger event information; and
activate, based on the display mode, the display unit.
